(19) United States
(12) Patent Application Publication
(10) Pub. No.: US 2003/0214141 A1
(43) Pub. Date: Nov. 20, 2003

(54) Dust can - an improved trash can which allows debris to be able to be swept directly into the bin when trash can is placed horizontally on its side

(76) Inventor: Susan Jane Morris, Sunset Hills, MO (US)

Correspondence Address: Susan Jane Morris, 12927 Baalbek DR., Sunset Hills, MO, 63127, US

(21) Appl. No.: 10/440,323

(22) Filed: May 16, 2003

Related U.S. Application Data
(60) Provisional application No. 60/381,410, filed on May 17, 2002.

(51) Int. Cl. A01B 1/02; A47F 13/08

(52) U.S. Cl. 294/55

(57) ABSTRACT

A thin protruding lip extension, built-in or attached to the main body of the trash can so as to allow debris to be swept directly into the trash bin when the trash can is placed horizontally on its side.

### CROSS-REFERENCE TO RELATED APPLICATIONS

Dust Can—PPA application No. 60381410 PPA filing date: May 17, 2002

### FEDERALLY SPONSORED RESEARCH

Not Applicable

### SEQUENCE LISTING OR PROGRAM

Not Applicable

### BACKGROUND OF THE INVENTION—FIELD OF THE INVENTION

This invention relates to relates to trash cans, specifically common household and kitchen type trash cans.

### BACKGROUND OF THE INVENTION

In trying to make everyday chores easier, I have invented an improved trash can which enables debris to be swept into the modified trash can when the trash can is placed on its side. As such, my invention eliminates the need for a dustpan. The most advanced prototype I have created to date consists of a thin lip extension (1) which is attached by hinges (3) to the trash bin (4) and performs to enable debris to easily enter the bin and may substitute for a hinged lid as well. This improvement is ideally suited to small and medium size household trash cans, such as those found in the kitchen, but is also applicable to outdoor (larger size) trash cans.

Traditionally, when sweeping the floor, debris is swept into a dust pan, and this debris is then dumped from the dust pan into a conventional trash can. My invention eliminates the need for a dust pan as an intermediary so that debris can be swept directly into the trash can via the thin lip extension (1) when the trash can is placed on its side (laying horizontally flat on the floor).

To date, no known trash can has been modified so that it can directly receive swept debris when placed horizontally on the floor (or other surface). However, relative prior art includes U.S. Pat. Nos. D467,696, D468,508, D470,289, D351,705, D473030 and others. Closest known prior art is U.S. Pat. No. D473030 which is an ornamental design patent comprised of a trash can with a dust pan cover (similar also to U.S. Pat. No. D351,705). However, it does not perform any new utility and does not combine the features into a single mechanism. My invention does this whereby the trash bin enabled to be used for directly receiving swept debris when placed on its side.

My invention may be considered as a single device whereby its overall new utility occurs in which the two main parts—the trash bin and the thin lip extension—are dependent on one another. The primary feature of my invention—the thin lip extension (1)—either molded into the shape of the trash can or attached by external means—is dissimilar to a dust pan in certain regards:

1) It is not intended to be an intermediate carrier of debris, and hence does not have a handle or back edge to contain debris.

2) It is not necessary for it to have the shape of a dust pan, the shape of simple thin edge lip will suffice for it to perform its task which is to provide a pathway directly into the bin.

3) It must be used in conjunction with the trash bin placed on its side to function.

For the trash can itself, the shape of the body may be square, rectangular, trapezoidal, or other preferably stable shapes, and the body should preferably have flat sides so as to lay horizontally flat on the floor to provide a stable platform to receive debris.

A variety of manufacturing processes are available to construct my invention, using existing manufacturing techniques.

Simple construction: The simplest manufacturing process would be to modify the existing molding shapes for trash cans, such that the novel feature lip is directly included as a part of the molding process.

Complex construction: The novel feature lip is attached to existing trash cans by a variety of means, including but not limited to the following:

a hinge attachment, allowing the thin lip extension feature (1) to substitute for a lid

a hinge attachment, allowing the thin-lip to flip up when needed

a sliding thin-lip extension

a self-contained lip extension, which could be fitted to existing production trash can (see FIGS. 7A to 8B).

other conventional attachment methods

### BACKGROUND OF INVENTION—OBJECTS AND ADVANTAGES

From the prior descriptions listed above, significant advantages are apparent of my invention:

(a) My invention makes the chore of sweeping much easer as it saves the steps of sweeping trash into dust pan and then emptying out the dust pan out into trash can.

(b) Only my invention and broom are needed.

(c) Saves labor time of finding dust pan to use to sweep up trash.

### SUMMARY

In accordance with the present invention a trash can modified so that debris can be easily swept into the bin when placed on its side, and this is made possible by a thin lip extension (1) which is joined to the trash can (2).

### DRAWINGS—FIGS. 1A to 8B.

Figures of the same prototype have the same number but different alphabetic suffixes.

Preferred Embodiment—Formal Drawings:

FIG. 1A shows the formal drawing of the preferred embodiment of my invention, whereas the thin lip extension (1) also functions as the lid and is joined to the trash can (2). The said thin lip extension is attached via hinges (3).

FIG. 1B shows the midpoint of transition into its operational form (see FIG. 1C).

FIG. 1C shows the new utility of the modified trash can, allowing debris to be swept directly into the bin.

Preferred Embodiment—Informal Drawings:

FIG. 2A shows a digitally scanned informal photograph showing the most advanced prototype constructed in which the lip extension also functions as the lid.

FIG. 2B shows the prototype transitioning to its operational form (see FIG. 2C for operational use).

FIG. 2C shows this prototype in its operational form whereby debris can be swept directly into the trash bin via the thin lip extension.

FIG. 2D shows a digitally scanned informal blueprint used to construct the prototype seen in FIGS. 2A through 2C.

Alternative Embodiments—Informal Drawings:

FIG. 3A represents another hinged prototype with the thin lip extension in an alternate position.

FIG. 3B shows how the thin lip extension folds up from the back side on this prototype.

FIG. 3C shows this prototype placed on floor for use.

FIG. 3D demonstrates how the invention works, showing the thin lip extension (shaped with secondary features) allowing debris to be easily swept in.

FIG. 3E shows a digitally scanned image of the blueprint used to construct the prototype shown in FIGS. 3A to 3D.

FIG. 4A represents a simple prototype in upright position with thin lip extension and side guards.

FIG. 4B shows the simple prototype version in use in its operational form.

FIG. 4C shows a digitally scanned image of the blueprint used to construct the prototype of FIGS. 4A and 4B.

FIG. 5A shows the simplest form of my invention, with a simple thin lip extension built-into the form of the trash can. The extension has no secondary features.

FIG. 5B shows simplest version prototype (lip extension built in) demonstrating extension lip in operational use.

FIG. 5C shows a digitally scanned image of the blueprint used to construct the simplest prototype.

FIG. 6 shows digitally scanned image for an alternative advanced prototype which includes a step lifter mechanism to open the thin lip extension which doubles as a lid.

FIG. 7A shows a digitally scanned image of informal drawing of a lip extension that could be attached to a trash bin via a self-contained attachment mechanism (clothes pin type mechanism of attachment).

FIG. 7B shows what the lid extension of FIG. 7A looks like when attached to the trash can.

FIG. 8A illustrates another possible shape of lip extension with a self-contained attachment mechanism (snap-on type) which could potentially attach to a trash can, as seen in FIG. 8B.

FIG. 8B. What this alternative embodiment looks like when extension is attached to body of trash can.

### DRAWINGS—REFERENCE NUMBERALS

1—Thin lip extension—the main feature of my invention which makes my invention functional at the point of novelty. It allows debris to be swept into a the trash can when trash can is placed on its side.

2—The body of the trash can.

3—hinge(s)—represent one possible method of attaching thin lip extension (#1) to body of trash can (#4).

4—side guards—a secondary feature which helps direct debris into the trash can.

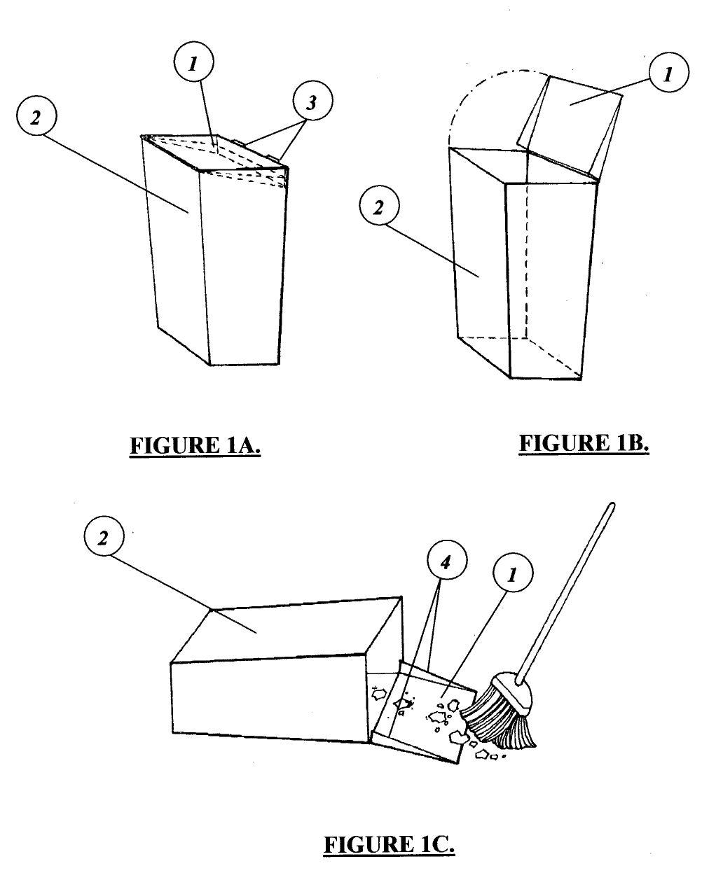

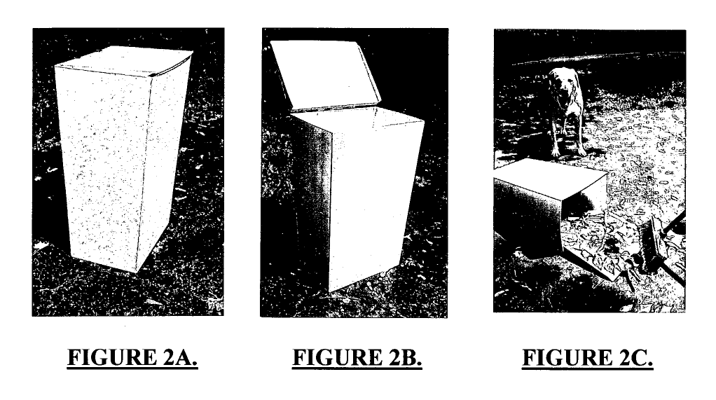

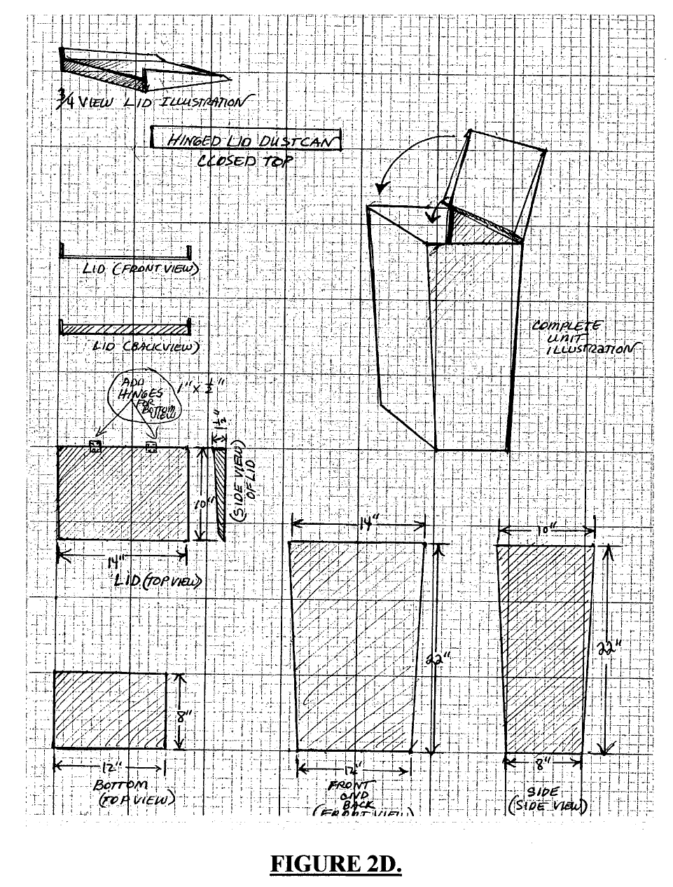

### DETAILED DESCRIPTION—FIGS. 1A to 2C (PREFERRED EMBODIMENT)

The primary novel feature of my invention is the thin protruding lip on the modified trash can lip which allows debris to be swept directly into the trash can when placed on its side (as shown in FIG. 1C). Secondary Features (for ease of use, but not essential to invention) include side guards (4) on the thin lip extension (1), and cloth-tape to cover the gap created between thin lip extension and trash bin.

FIG. 2A is a photograph of the most advanced prototype of and shows how the prototype looks in its upright conventional position, acting as a trash can. Its novel feature—the thin lip extension, which allows the novel utility of sweeping debris directly into the bin when placed on its side, is also able to substitute for a lid for the trash can due to its ideal size, placement of hinges, and method of attachment.

FIG. 2B demonstrates the conversion of this advanced prototype into its operational form (FIG. 2C). Figure also shows how thin lip extension also substitutes as a hinged lid for the body of the trash bin.

FIG. 2C demonstrates the novelty and use of my invention, as my invention is placed on its side and the thin lip extension is folded out, showing how the lip extension allows trash to be swept directly into it when placed on its side.

Currently, I am performing additional secondary modifications to this prototype, by using cloth tape to cover the gap between the lip extension and the bin so as to prevent fine debris from failing through the gap.

### OPERATION—FIGS. 1A to 2C

In operation the trash can modified by a thin edge extension (1) allows for removal of swept debris by placing the trash can (2) on its side and sweeping the debris directly into the trash bin (see FIG. 1C). FIG. 1A shows the preferred embodiment in the conventional upright position. FIG. 1B shows the transitional step to its intended operational state. FIG. 1C demonstrates the novelty of operation of my invention, showing the trash can horizontally on its side with the thin lip extension (1) providing the means to direct debris into the trash bin.

FIGS. 2A to 2C are informal photographs of the preferred embodiment and compliment FIGS. 1A to 1C respectively.

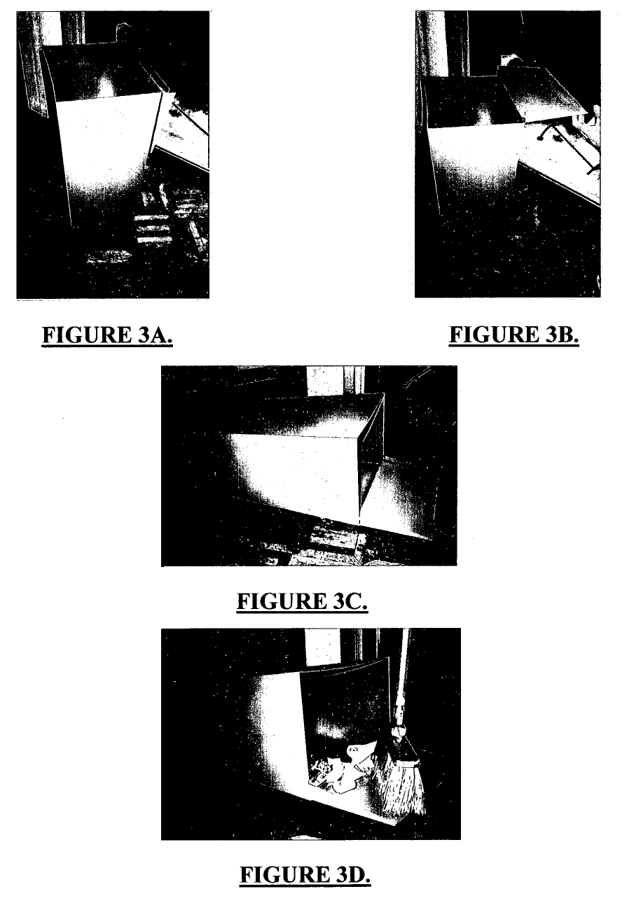

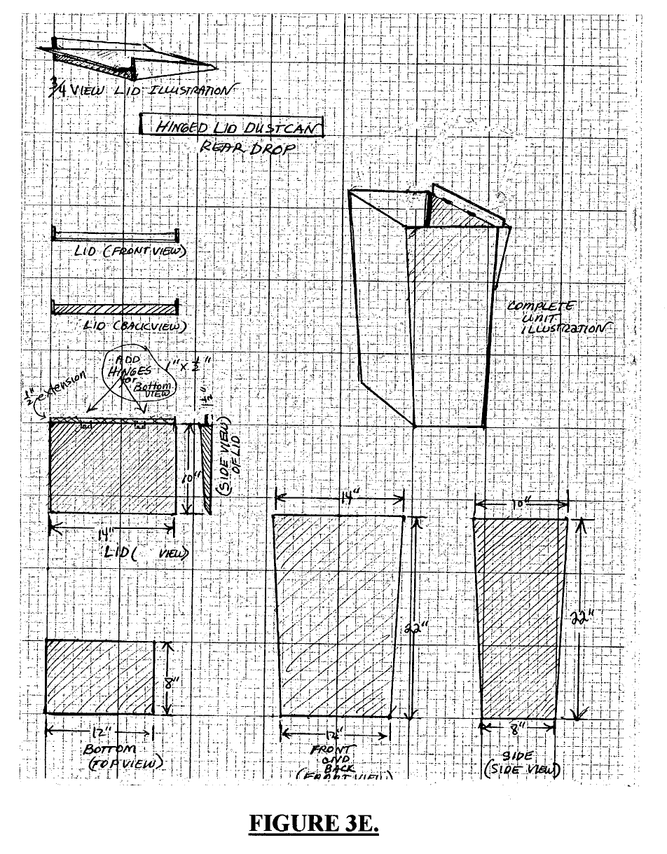

### DESCRIPTION AND OPERATION OF ALTERNATIVE EMBODIMENTS—FIGS. 3A TO 8B.

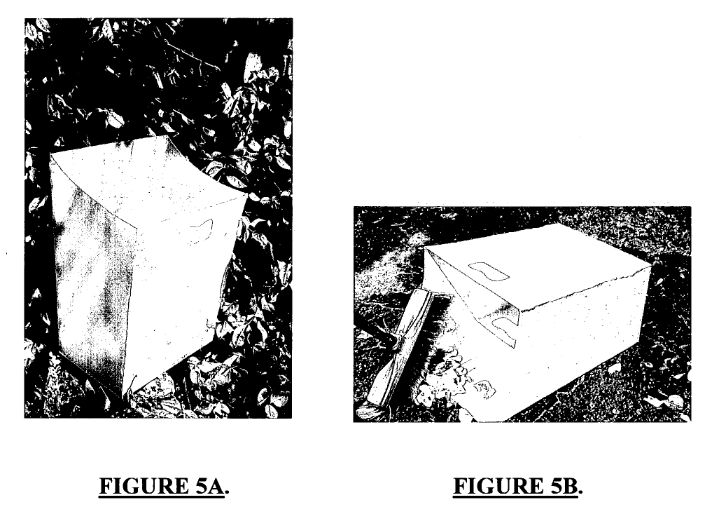

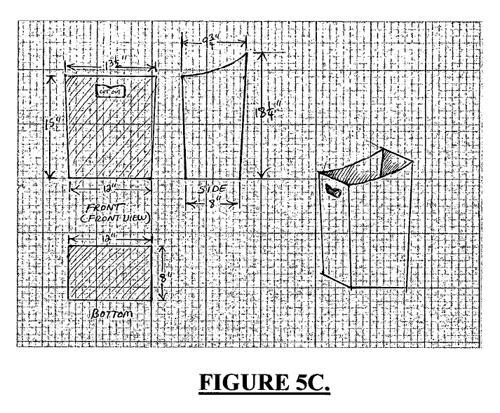

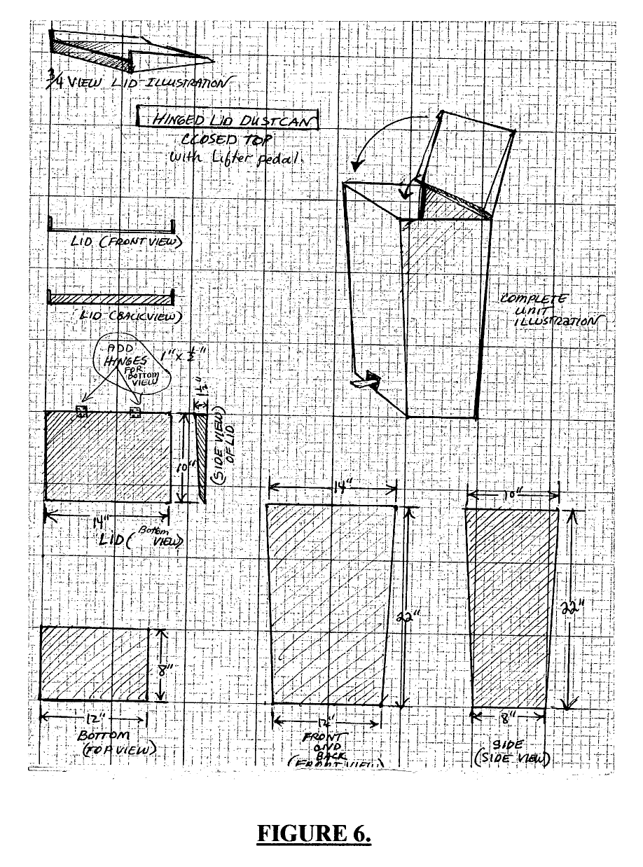

FIG. 5A shows a digitally scanned photograph of the simplest possible version of my invention, whereby the thin lip extension is included directly into the trash bin by virtue of the shape of the trash can. The photograph of FIG. 5B demonstrates the novel operational utility of this simplest version, eliminating the need for a dust pan as an intermediate carrier of debris. FIG. 5C shows the informal blueprint of the simplest prototype.

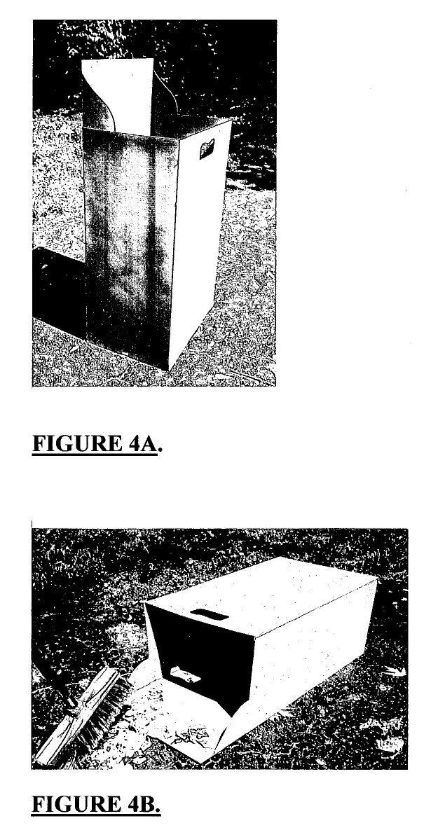

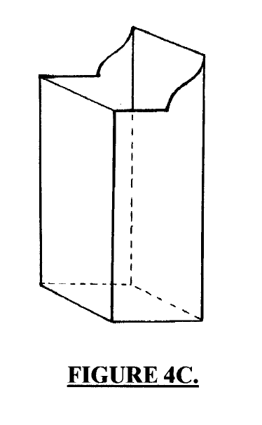

An even more complex prototype is shown in FIGS. 4A-4C, which has side guards to direct debris into trash bin. As with all versions, the prototype must be placed horizontally to perform its novel function.

FIGS. 3A-3E show a more complex prototype whereby the thin lip extension is sloped with side guards and is attached via hinges, which makes it more ergonomic. In addition, the lip extension is modified slightly with its own protruding lip (XXX-scan) so that the debris can be swept over the gap created between the trash can and the extension. FIGS. 3A to 3D can also be considered an operational sequence (in respective order), whereby the modified trash can goes from its normal conventional use (FIG. 3A) and transitions (FIG. 3B) into a new use (FIGS. 3C and 3D).

FIG. 6 shows an informal drawing of an alternate embodiment with a step-pedal lid opener mechanism, although this is unnecessary to the primary function of my invention.

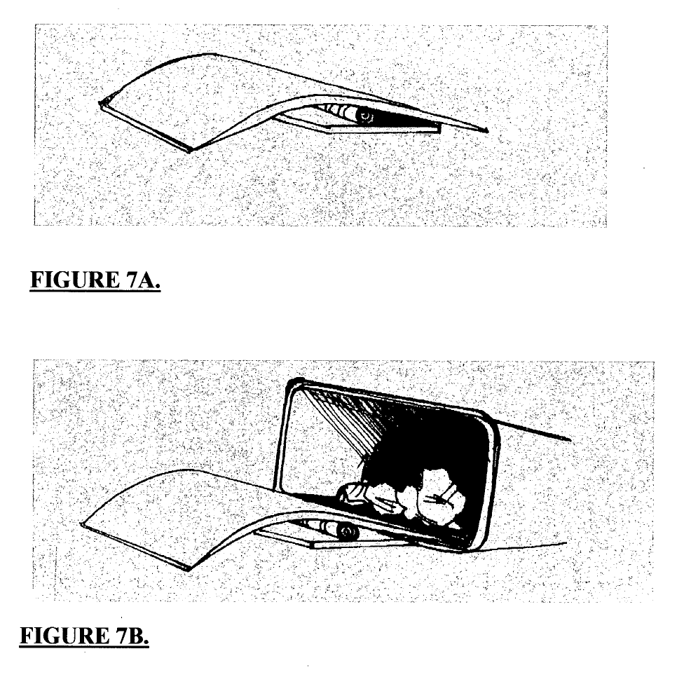

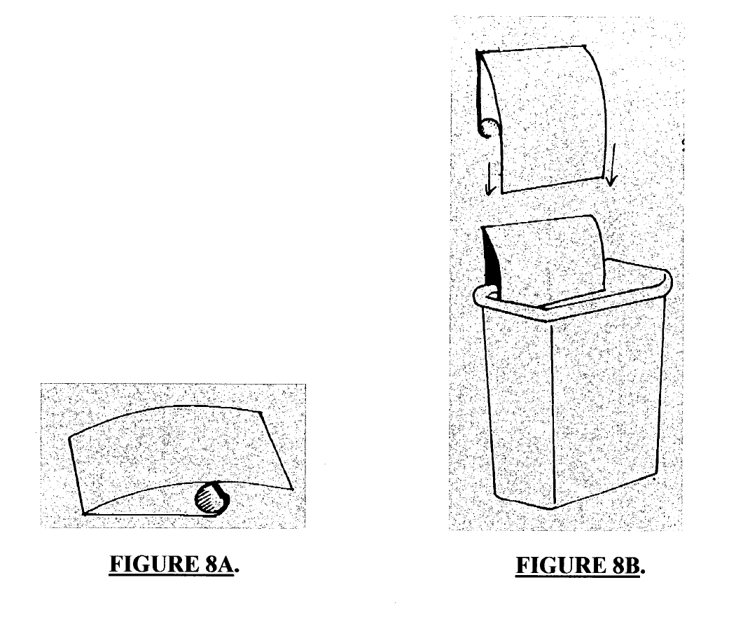

The remaining FIGS. 7A to 8B represent lip extensions in which the attachment mechanism is self-contained on the lip extension itself. FIG. 7A shows scanned image (informal) a self-contained lip extension that could be attached to a trash bin (in this case a clothes-pin hinge type attachment). FIG. 7B how this alternative embodiment of my invention looks in its complete form. In this alternative the extension has a clothes pin mechanism of attachment which could potentially attach to many existing versions of trash cans. FIG. 8A shows another important alternative embodiment of a self-contained lip extension, a fitted snap-on piece custom formed to attach to the bin. FIG. 8B shows this snap-on lip attachment attached to the body of trash can so that debris can be swept directly into trash bin when bin is placed on its side.

### CONCLUSION, RAMIFICATIONS, AND SCOPE OF INVENTION

To my knowledge, no one else has yet invented a device which enables a conventional trash can to receive swept debris when the trash can is placed horizontally on the floor. My invention is in essence a modified trash can which performs in an entirely new way, by virtue of the thin lip extension (1) which allows it to receive swept debris. The thin lip extension could not perform its function without the trash bin, conversely the trash bin could not perform its new function without the thin lip extension. The potential ramifications of my invention include common household use due to convenience of allowing trash to be swept directly into the trash can.

With regard to all of the alternative embodiments, and all embodiments give the now modified trash can a new use (i.e. allows debris removal) when trash can is placed horizontally on the floor. For example, the variations may or may not have the primary lip extension feature built directly into the side but rather added as an attachment, a snap-on, etc. The secondary features such as side guards, sloping (wedge) shape, etc. are useful but not absolutely necessary.

I believe myself to be the first true inventor of my invention, an improved trash can which allows debris to be swept directly into the trash can when the trash can is placed on its side. The usefulness of my invention saves time and may be easily incorporated onto conventional trash cans. As there are many possible embodiments, the scope of the invention should be determined by the claims and their legal equivalents.

1. A trash can, modified so that at least one side of the trash can (2) is modified in such a way that includes a thin lip extension (1) either built-in or attached to said trash can, whereby:
a. The said thin lip extension of claim 1 allows debris to be swept directly into said trash can when
b. The said trash can of claim 1a is placed horizontally on the floor.

2. A method of removing swept debris using a trash can (2) as a container, comprising of the following steps whereby:
a. The said trash can of claim 2 is joined to a thin lip extension (1) or with said thin lip extension built-in, and
b. The said trash can of claim 2 is placed horizontally on a surface whereby
c. debris is swept onto and over said thin lip extension and into the said trash can of claim 2b.
